(19) United States
(12) Patent Application Publication
(10) Pub. No.: US 2024/0224385 A1
(43) Pub. Date: Jul. 4, 2024

(54) Cooling Umbrella Device

(71) Applicant: Debbie Grierson, Philadelphia, PA (US)

(72) Inventor: Debbie Grierson, Philadelphia, PA (US)

(21) Appl. No.: 18/404,490

(22) Filed: Jan. 4, 2024

Related U.S. Application Data
(60) Provisional application No. 63/437,019, filed on Jan. 4, 2023.

(51) Int. Cl. H05B 3/22; A45B 25/00

(52) U.S. Cl. CPC H05B 3/22; A45B 25/00; A45B 2025/003; A45B 2200/1036; A45B 2200/1045; A45B 2200/1081

(57) ABSTRACT

A cooling umbrella device is provided. The device is comprised of a body, a shaft, handle, and at least one heating/cooling unit. The device allows users to easily activate the heating/cooling unit to maintain a comfortable environment while shielding harmful sunrays outdoors under the umbrella body.

### CROSS-REFERENCE TO RELATED APPLICATION

The present application claims priority to, and the benefit of, U.S. Provisional Application No. 63/437,019, which was filed on Jan. 4, 2023, and is incorporated herein by reference in its entirety.

### FIELD OF THE INVENTION

The present invention relates generally to the field of umbrellas. More specifically, the present invention relates to a cooling umbrella device comprised of a heating/cooling umbrella unit that can be used to cool the user and prevent the overheating of the user. Accordingly, the present disclosure makes specific reference thereto. Nonetheless, it is to be appreciated that aspects of the present invention are also equally applicable to other like applications, devices, and methods of manufacture.

### BACKGROUND

When using an umbrella, the umbrella body serves as a versatile and indispensable tool, offering not only a practical means of shelter but also a crucial shield against the elements. On a sunny day, the umbrella's wide canopy casts a protective shadow over the user, providing much-needed relief from the intense heat and the potentially harmful effects of prolonged sun exposure. In fact, prolonged sun exposure can lead to various health risks, ranging from mild discomforts like sunburns to more severe conditions such as sunstroke, heat exhaustion, and dehydration. It is especially important to be cautious during peak hours when the sun's intensity is at its highest. With an umbrella, however, a user can substantially reduce these risks, making outdoor activities safer and more enjoyable.

Moreover, the long-term consequences of constant exposure to the sun cannot be ignored. Over the years, cumulative exposure to UV radiation can wreak havoc on our skin's health, leading to premature aging, wrinkles, and an uneven complexion. More alarmingly, this exposure can contribute to the development of skin cancer, which is one of the most common types of cancer worldwide. By seeking shelter under an umbrella when the sun is at its harshest, a user can actively take steps to protect their skin's health

However, existing umbrellas known in the art do not provide additional means of cooling a user beyond providing shade. This is undesirable, as in some extremely hot environments more cooling is desired. In addition, umbrellas may also be used on cold, rainy days wherein a heating element is desired from the umbrella.

Therefore, there exists a long-felt need in the art for a device that cools individuals while outside. More specifically, there exists a long-felt need in the art for a cooling umbrella device that can shield a user from the sunlight while cooling the user to prevent sunstroke, heat exhaustion, dehydration, etc. Furthermore, there exists a long-felt need in the art for a cooling umbrella device that can cool users while in extremely arid environments while eliminating skin exposure to intense UV rays.

The subject matter disclosed and claimed herein, in one embodiment thereof, comprises a cooling umbrella device. The device is comprised of a body, preferably made from UV ray-protecting material, a shaft, and a heating/cooling unit. The heating/cooling unit can be secured in the upper body of the umbrella and can be activated to heat or cool the user depending on the surrounding environment. The shaft should include a handle made of rubber-like gripping material ensuring a firm grasp on the device.

In this manner, the cooling umbrella device of the present invention accomplishes all the forgoing objectives and provides a device that protects and cools users while in intense sunlight. More specifically, the cooling umbrella device can eliminate sunstroke, dehydration, sunburn, heat exhaustion, and unhealthy skin diseases from its users. Furthermore, the device can be universally applied to any individual in outdoor conditions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cooling umbrella device comprised of a body, a shaft, and heating/cooling unit. The device is designed to heat or cool a user while protecting the user from intense UV rays from the sun in extreme weather climates.

The body is preferably made from a nylon or polyester material that allows for airflow and shields UV rays from the user. The body is preferably canopy-like in shape to allow for precipitation or condensation to stream off the exterior surface. Further, the body connects to the shaft. In one embodiment, the shaft is telescopic to allow the shaft and device to collapse when not in use. In this embodiment, the shaft is comprised of at least one locking mechanism to secure the body in the open position while also securing the shaft at a desired length.

Further, the shaft connects to the handle. The handle may be comprised of at least one grip area that provides a firm grip to secure the handle. The grip area may also be comprised of a raised or recessed texture to improve grip.

The handle is also comprised of at least one button that allows at least one cooling/heating element to power on and off. Additionally, the button 124 can adjust the temperature setting (ex. low, medium, high) along with the level of airflow outputted from the element depending on the user's need.

The heating/cooling unit is comprised of at least one heating/cooling element. In one embodiment, the cooling element is a fan that provides downward-flowing air onto the user. The heating/cooling element provides various levels of airflow (ex. low, medium, high, etc.) to maintain the desired temperature, which can be selected by the button. In another embodiment, the heating/cooling element is comprised of at least one electric heating coil to provide heat in cold weather.

The present invention is also comprised of a method of using the device. First, a device is provided comprised of a body, a shaft having a handle, at least one heating/cooling unit, and at least one button. Then, a user can open the body. Next, a user can lock the body and shaft into an open position using the locking mechanism of the shaft. Then, a user can press the button to power on the heating/cooling unit. Finally, a user can select the level of intensity of the heating/cooling unit using the button.

Accordingly, the cooling umbrella device of the present invention is particularly advantageous as it provides a device that provides temperature relief in outdoor environments while providing protection from UV rays. More specifically, the cooling umbrella device can reduce sunstroke, dehydration, sunburn, heat exhaustion, and unhealthy skin disease. Furthermore, the device can be universally applied to any individual in various outdoor conditions. In this manner, the cooling umbrella device overcomes the limitations of existing umbrellas known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cooling umbrella device of the present invention while opening in accordance with the disclosed architecture; and

FIG. 2 illustrates a flowchart of a method of using one potential embodiment of a cooling umbrella device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that cools individuals while outside. More specifically, there exists a long-felt need in the art for a cooling umbrella device that can shield users from the sunlight while cooling the user to prevent sunstroke, heat exhaustion, dehydration, etc. Furthermore, there exists a long-felt need in the art for a cooling umbrella device that can cool users while in extremely arid environments while eliminating skin exposure to intense UV rays.

The present invention, in one exemplary embodiment, is comprised of a cooling umbrella device. The device is comprised of a body, a shaft, and a heating/cooling unit. The device is designed to heat or cool a user while protecting the user from intense UV rays from the sun in extreme weather climates.

The body is preferably made from a nylon or polyester material that allows for airflow and shields UV rays from the user. The body is preferably canopy-like in shape to allow for precipitation or condensation to stream off the exterior surface. The body is connected to a shaft which may be telescopic to allow the shaft and device to collapse when not in use. The telescopic shaft may be comprised of at least one locking mechanism to secure the body in the open position while also securing the shaft at a desired length.

Further, the shaft connects to the handle which may be comprised of at least one grip area. The grip area provides a firm grip to secure the handle. The grip area may also be comprised of a raised or recessed texture to improve grip.

The handle is also comprised of at least one button. The button allows at least one cooling/heating element to power on and off. Additionally, the button 124 can adjust the temperature setting (ex. low, medium, high) along with the level of airflow outputted from the element depending on the user's need.

The heating/cooling unit is comprised of at least one heating/cooling element. In one embodiment, the cooling element is a fan that provides downward-flowing air onto the user. The heating/cooling element provides various levels of airflow (ex. low, medium, high, etc.) to maintain the desired temperature, which can be selected by the button. In another embodiment, the heating/cooling element is comprised of at least one electric heating coil to provide heat in cold weather.

The present invention is also comprised of a method of using the device. First, a device is provided comprised of a body, a shaft having a handle, at least one heating/cooling unit, and at least one button. Then, a user can open the body. Next, a user can lock the body and shaft into an open position using the locking mechanism of the shaft. Then, a user can press the button to power on the heating/cooling unit. Finally, a user can select the level of intensity of the heating/cooling unit using the button.

Accordingly, the cooling umbrella device of the present invention is particularly advantageous as it provides a device that provides temperature relief in outdoor environments while providing protection from UV rays. More specifically, the cooling umbrella device can reduce sunstroke, dehydration, sunburn, heat exhaustion, and unhealthy skin disease. Furthermore, the device can be universally applied to any individual in various outdoor conditions. In this manner, the cooling umbrella device overcomes the limitations of existing umbrellas known in the art.

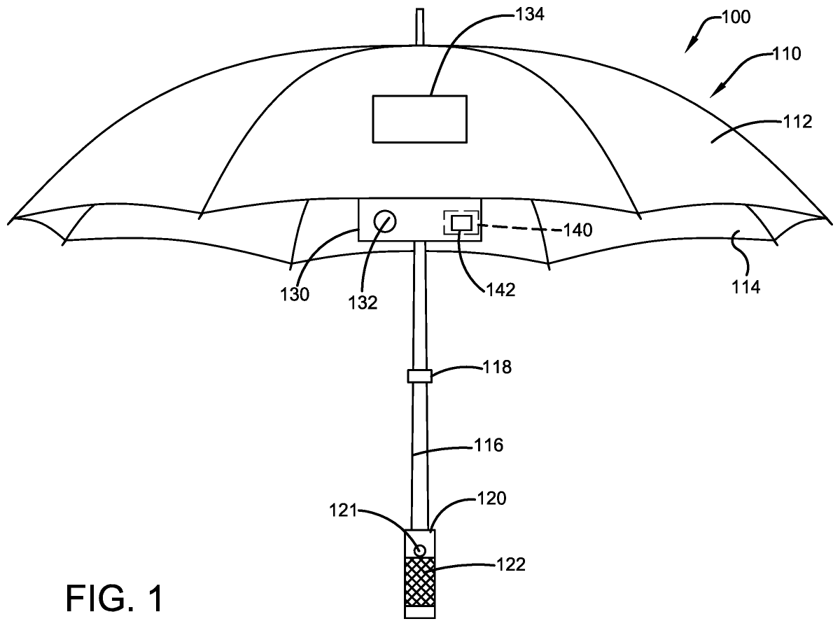

Referring initially to the drawings, FIG. 1 illustrates a perspective view of one potential embodiment of a cooling umbrella device 100 of the present invention while opening in accordance with the disclosed architecture. The device 100 is comprised of a body 110, a shaft 116, a handle 120, and a heating/cooling unit 130. The device 100 is designed to provide ventilation in various outdoor environments while providing protection from severe UV rays.

The body 110 is preferably made from a nylon or polyester material that allows for airflow and shields UV rays from the user. The body 110 may also be waterproof. However, the body 110 may be made from any umbrella material known in the art. The body 110 is preferably canopy-like in shape to allow for precipitation or condensation to stream off the exterior surface 112. The body 110 is comprised of an interior surface 112 that provides a shield from various elements. Further, the body 110 connects to the shaft 116.

The shaft 116 is preferably made from a lightweight, metal material. In one embodiment, the shaft 116 is of a fixed length. In another embodiment, the shaft 116 is telescopic to allow the shaft 116 and device 100 to collapse when not in use. In this embodiment, the shaft 116 is comprised of at least one locking mechanism 118 to secure the body 110 in the open position while also securing the shaft 116 at a desired length. Further, the shaft 116 connects to the handle 120.

The handle 120 is preferably made from a durable plastic or rubber material. The handle 120 is comprised of at least one grip area 122. The grip area 122 is preferably made from a rubber-like material. Said material provides a firm grip to secure the handle 120, of said device 100, in the user's hand. The grip area 122 may also be comprised of a raised or recessed texture to improve grip.

The handle 120 is comprised of at least one button 124 that allows at least one cooling/heating element 130 to power on and off. Additionally, the button 124 can adjust the temperature setting (ex. low, medium, high) along with the level of airflow outputted from the element 130 depending on the user's need.

The heating/cooling unit 130 is preferably made from a durable plastic material. Said material provides durability through various weather conditions. The heating/cooling unit 130 is comprised of at least one heating/cooling element 132. In one embodiment, the cooling element 132 is a fan that provides downward-flowing air onto the user. In another embodiment, the cooling element 132 is a misting fan providing a water mist in addition to airflow providing downward-flowing air onto the user. The heating/cooling element 132 provides various levels of airflow (ex. low, medium, high, etc.) to maintain the desired temperature, which can be selected by the button 124.

In another embodiment, the heating/cooling element 132 may be comprised of a unit 130 to accommodate cold weather. In this embodiment, the heating/cooling element 132 is comprised of at least one electric heating coil. In another embodiment, the heating/cooling element 132 is at least one electric heating coil with a fan providing downward-flowing air onto the user.

The heating/cooling unit 130 is powered by at least one battery 130. The battery 130 can be powered by a solar panel 134 located on the exterior surface 112 of the body 110 in one embodiment. Further, the battery 140 will continue to recharge while in use. In a different embodiment, the battery 140 may be charged using the charging port 142 such as but not limited to a USB port. In a further embodiment, the battery 140 is a removable, disposable or rechargeable battery.

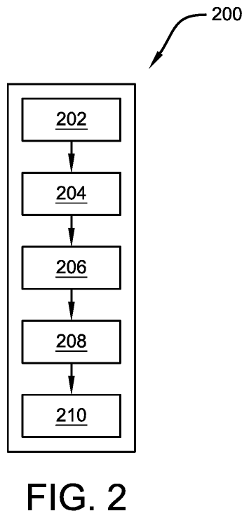

The present invention is also comprised of a method of using 200 the device 100, as seen in FIG. 2. First, a device 100 is provided comprised of an umbrella body 110, a shaft 116 having a handle 120, at least one heating/cooling unit 130, and at least one button 124 [Step 202]. Then, a user can open the body 110 [Step 204]. Next, a user can lock the body 110 and shaft 116 into an opened position using the locking mechanism 118 of the shaft 116 [Step 206]. Then, a user can press the button 124 to power on the heating/cooling unit 130 [Step 208]. Finally, a user can select the level of intensity of the heating/cooling unit 130 using the button 124 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cooling umbrella device” and “device” are interchangeable and refer to the cooling umbrella device 100 of the present invention.

Notwithstanding the forgoing, the cooling umbrella device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cooling umbrella device 100 as shown in the FIGS. are for illustrative purposes only, and that many other sizes and shapes of the cooling umbrella device 100 are well within the scope of the present disclosure. Although the dimensions of the cooling umbrella device 100 are important design parameters for user convenience, the cooling umbrella device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooling umbrella device comprising:
an umbrella body;
a shaft;
a handle;
a heating and cooling element; and
a battery that powers the heating and cooling element.

2. The cooling umbrella device of claim 1, wherein the shaft is comprised of a telescopic shaft.

3. The cooling umbrella device of claim 2, wherein the shaft is comprised of a locking mechanism.

4. The cooling umbrella device of claim 1, wherein the handle is comprised of a grip area.

5. The cooling umbrella device of claim 1, wherein the handle is comprised of a button.

6. The cooling umbrella device of claim 5, wherein the button turns the heating and cooling element on and off.

7. The cooling umbrella device of claim 5, wherein the button adjusts a temperature setting of the heating and cooling element.

8. The cooling umbrella device of claim 1, wherein the heating and cooling element is comprised of a fan or a misting fan.

9. The cooling umbrella device of claim 1, wherein the heating and cooling element is comprised of an electric heating coil or an electric heating coil with a fan.

10. A cooling umbrella device comprising:
an umbrella body;
a shaft;
a handle;
a heating and cooling element;
a battery that powers the heating and cooling element; and
a solar panel positioned on the umbrella body, wherein the solar panel powers the battery.

11. The cooling umbrella device of claim 10, wherein the shaft is comprised of a telescopic shaft.

12. The cooling umbrella device of claim 11, wherein the shaft is comprised of a locking mechanism.

13. The cooling umbrella device of claim 10, wherein the handle is comprised of a grip area.

14. The cooling umbrella device of claim 10, wherein the handle is comprised of a button.

15. The cooling umbrella device of claim 14, wherein the button turns the heating and cooling element on and off.

16. The cooling umbrella device of claim 14, wherein the button adjusts a temperature setting of the heating and cooling element.

17. The cooling umbrella device of claim 10, wherein the heating and cooling element is comprised of a fan or a misting fan.

18. The cooling umbrella device of claim 10, wherein the heating and cooling element is comprised of an electric heating coil or an electric heating coil with a fan.

19. A method of using a cooling umbrella device, the method comprising the following steps:
providing a cooling umbrella device comprised of an umbrella body, a shaft comprised of a handle, a unit, and a button;
opening the body; and
pressing the button to power on the unit.

20. The method of using a cooling umbrella device of claim 19, wherein the unit is comprised of a cooling unit, a heating unit, or a heating and cooling unit.
